(19) United States
(12) Patent Application Publication
(10) Pub. No.: US 2019/0310189 A1
(43) Pub. Date: Oct. 10, 2019

(54) APPARATUS AND METHOD FOR DETERMINING A REFRACTIVE INDEX

(71) Applicant: KONINKLIJKE PHILIPS N.V., EINDHOVEN (NL)

(72) Inventor: Niels Agersnap LARSEN, NIVAA (DK)

(21) Appl. No.: 16/467,071

(22) PCT Filed: Dec. 8, 2017
(86) PCT No.: PCT/EP2017/081935

§ 371 Date: Jun. 6, 2019

(30) Foreign Application Priority Data
Dec. 8, 2016 (EP) 16202907.8

(51) Int. Cl. G01N 21/41; G02B 27/42; H04N 5/225; H04N 7/18; G06K 9/20

(52) U.S. Cl. CPC G01N 21/4133; G02B 27/4205; H04N 5/2254; G01N 2201/12; H04N 7/183; G06K 9/2036; H04N 5/2253

(57) ABSTRACT

An apparatus (100), a method and a cartridge (10) for determining a refractive index (ns) of a sample (12) are provided. The apparatus (100) comprises a cartridge (10) for receiving the sample (12) and an imaging unit (102) comprising a light source (104) for irradiating the cartridge (10) with a light beam (106), an image sensor (108) for capturing an image (122a) of said part of the cartridge (10), an objective lens (114), and a processing module (116) for analyzing the captured image (122a). The cartridge (10) comprises an optical element (20) configured to refract and/or diffract the light beam (106), wherein the objective lens (114) is arranged to receive the refracted and/or diffracted part of the light beam (106). The processing module (116) is configured to determine a transmittance (T) and/or a reflectance (R) of the sample (12) by analyzing an image intensity of the captured image (122a), and to determine the refractive index (ns) of the sample (12) based on the transmittance (T) and/or based on the reflectance (R).

### FIELD OF THE INVENTION

The present invention generally relates to the determination and/or measurement of a refractive index of a sample and/or a sample material. Particularly, the invention relates to an apparatus for determining a refractive index of a sample, to a cartridge for use in such apparatus, and to a method for determining a refractive index of a sample.

### BACKGROUND OF THE INVENTION

Various methods and/or devices are commonly used for determining and/or measuring a refractive index (RI) of a sample and/or a sample material.

One of those methods is based on a detection of a critical angle, which refers to a minimum angle of incidence at which light is totally reflected at a boundary defined by two media of different refractive indices. The phenomenon of total reflection, however, only occurs for light propagating from high RI material to a low RI material. Thus, such method of determining the RI, which is e.g. applied in the so-called Abbé and Pulfrich refractometers, has certain limitations due to physical constraints.

A further commonly used approach is based on the detection of the Brewster angle, which refers to an angle of incidence of light at a planar boundary between media of different refractive indices, wherein at the Brewster angle a reflection of p-polarized light vanishes. Similar to the critical angle, this phenomenon only takes place for light propagating from high RI material to low RI material.

Another widely used method is based on Surface plasmon resonance (SPR). By way of example, the so-called Kretschmann prism sensor is a well-known realization of the SPR principle.

Another method for determining the RI is based on an angular beam deviation by refraction, wherein a light beam is directed towards a container with an unknown fluid. The geometry and RI of the container are assumed to be known. The exit direction of the beam depends on the boundaries through which the beam passes, particularly the container-fluid boundary since the refraction is sensitive to the RI of the fluid. Thus measurement of the exit beam direction and/or an offset between the incoming and the exiting beam provides a measure for the RI of the fluid. An example for a device employing this method is the so-called Hilger-Chance angular deviation refractometer.

Other methods to measure refractive index of fluids are based on interference of two beams of light, such as used e.g. applied in a Michelson interferometer. Generally, in such two-beam interferometer approach a phase difference between the two beams occurs, because one beam is propagated through the unknown fluid and the other through a known material. By measuring the required displacement of the fluid volume to generate a 2n phase shift between the two beams the RI of the fluid can be determined.

### SUMMARY OF THE INVENTION

It may be an object of the present invention to provide an apparatus and a method for determining a refractive index (RI) and/or other parameters of a sample in a precise, cost-efficient and robust manner, while also overcoming at least a part of the drawbacks of presently used systems and methods.

This object is achieved by the subject matter of the independent claims, wherein further embodiments are incorporated in the dependent claims and the following description.

According to a first aspect of the invention, an apparatus for determining and/or measuring a refractive index of a sample and/or a refractive index of a sample material is provided. The apparatus comprises a cartridge for receiving the sample and an imaging unit. Therein, the imaging unit comprises a light source for emitting a light beam and for irradiating at least a part of the cartridge with the light beam. The imaging unit further comprises an image sensor with a plurality of photosensitive pixels for capturing an image of said part of the cartridge, an objective lens arranged in a light path between the light source and the image sensor, and a processing module for analyzing the captured image.

Therein, the cartridge comprises an optical element configured to refract and/or diffract at least a part of the light beam, wherein the objective lens is arranged to receive and/or collect the refracted and/or diffracted part of the light beam. Further, the processing module is configured to determine a transmittance and/or a reflectance of the sample by analyzing an image intensity of the captured image, and the processing module is configured to determine the refractive index of the sample based on the transmittance and/or based on the reflectance.

According to a second aspect of the invention, a cartridge for use in the apparatus as described above and in the following is provided.

According to a third aspect of the invention, a method for determining a refractive index of a sample is provided.

It should be noted that features, elements, characteristics and/or functions of the apparatus may be features, elements, characteristics and/or functions of the cartridge as well as features, elements, characteristics and/or steps of the method. Vice versa, features, elements, characteristics and/or functions of the cartridge as well as features, elements, characteristics and/or steps of the method as described above and in the following may be features, elements, characteristics and/or steps of the apparatus. In other words, all features, functions, characteristics and/or elements described with respect to one aspect of the invention may also refer to any of the other aspects of the invention.

Here and in the following the sample may refer to a fluid sample, such as any sample comprising gaseous and/or liquid material, as well as to a sample comprising solid-state material. Also, the invention may be applied to any sample comprising a mixture of fluid and solid-state material. By way of example, the sample may be a urine sample. Moreover, in the context of the application, the term “sample” may refer to “sample material”.

Here and in the following the term “imaging unit” may refer to an imaging arrangement comprising at least the light source, the image sensor and the processing module. Therein, the “image sensor” may denote an image detector for detecting light and/or for converting light into an electrical signal, which may be further processed, e.g. by the processing module. For instance, the image sensor may comprise an array of photosensitive pixels, such as e.g. CCD and/or CMOS based pixels. The array of photosensitive pixels may be one-dimensional, i.e. the image sensor may comprise a line sensor array, or two-dimensional.

The term “processing module” may in the context of this application refer to a processing unit, a processing circuit and/or a processing circuitry configured, among others, for image processing. The processing module may be at least partly integrated in the imaging unit and/or arranged in the imaging unit. Alternatively, the processing module may be remote and/or remotely arranged from the remaining components of the imaging unit.

Further, the light source may refer to any illumination device emitting light of arbitrary wavelength. The light source may e.g. refer to a white light source or a laser source.

Moreover, the apparatus may be partly or fully integrated in an imaging system, such as e.g. a microscope. Accordingly, the apparatus may refer to a microscope, which may be operated in transmission mode and/or in reflection mode.

Re-phrasing the first aspect of the invention, the apparatus comprises the imaging unit and a cartridge, in which and/or on which a sample may be arranged. Light emitted by the light source in an emitting direction may propagate in form of the light beam along the light path from the light source to the image sensor. This comprises transmission of the light beam through the cartridge and/or the sample as well as refection of the light beam on the cartridge and/or the sample. The cartridge with the sample and the optical element may be arranged in the light path, wherein at least a part of the light beam may be refracted and/or diffracted by the optical element. Therein, refraction may refer to a directional change of light waves of the light beam caused by different propagation speeds of the light beam in materials with different refractive indices. Accordingly, refraction may lead to a change of a beam direction, wherein the light beam impinging onto the optical element in the emitting direction may be directed into at least one further direction, wherein the at least one further direction may equal to or differ from the emitting direction. Accordingly, refraction may also lead to a reflection of at least a part of the light beam. On the other hand, diffraction may refer to a bending of light waves of the light beam at obstacles and/or at openings provided by the optical element, wherein a diffraction pattern and/or at least one diffraction order may be generated. In other words, at least a part of the light beam may be diffracted into at least one diffraction order. Further, diffraction of at least a part of the light beam may also lead to a reflection of at least a part of the light beam into at least one reflection order.

Further, the refracted and/or diffracted part of the light beam may be at least partly collected by the objective lens, which in turn generates and/or forms an image of the refracted and/or diffracted part of the light beam on the image sensor. The objective lens may also infer a certain magnification. The image formed by the objective lens may be detected by means of at least a part of the photosensitive pixels, which generate and/or output an electrical signal correlating with an intensity of light impinging onto the respective photosensitive pixel. The processing module and/or the imaging unit may then evaluate the electrical signals of at least the part of the photosensitive pixels, which detected the image formed by the objective lens. The processing module and/or the imaging unit may also be configured to store a digital image data of the captured image, e.g. in a data storage device of the apparatus, and further process the digital image data. Accordingly, the captured image may refer to digital image data. By evaluating the electrical signals of the photosensitive pixels correlating with the light intensity and/or by evaluating the digital image data, the processing module may analyze the image intensity of the captured image and derive the transmittance and/or the reflectance of the sample therefrom. Based on the transmittance and/or the reflectance the processing module may finally derive, determine and/or calculate the refractive index of the sample.

Generally, by evaluating the captured image and/or the image intensity of the captured image the apparatus may provide a robust, cost-efficient and precise approach for determining the refractive index. Moreover, this allows to apply corrections for the measurement of the refractive index, e.g. inferred by impurities contained in the sample. By way of example, if the refractive index of urine is to be determined, particles, dust, bacteria or the like may cause a bias in the measurement and/or the determination of the refractive index of urine. Such bias and/or impurities may easily be corrected for with the apparatus as explained in more detail in the following. Also, e.g. for determining the refractive index of a sample containing impurities and/or additives due to a fermentation process, such as e.g. yeast, the apparatus may advantageously be used in order to correct for these impurities.

Apart from that, in contrast to many commonly known methods the apparatus according to the invention does not require a well-defined beam and/or beam orientation, such as e.g. a precise collimation and/or a specific angle of incidence of the beam. Accordingly, the apparatus may provide a robust, cost-efficient and precise determination of the refractive index. Further, the apparatus may easily be integrated into and/or retrofitted to an imaging system, such as a microscope.

Further, the apparatus may advantageously have an inherent phase sensitivity, and thus precision, in common with interferometer methods for determining the refractive index, but the apparatus may be highly simplified in practical use due to a fixed and/or stationary as well as compact geometry of the apparatus compared to interferometers. Moreover, in contrast to known methods an angular beam quality may not be critical in the inventive apparatus. This generally may allow a compact and cost-effective design of the apparatus, without a need for a very precise alignment, e.g. in an imaging system.

According to an embodiment, the processing module is configured to filter out predefined structures in the captured image related to additives and/or impurities in the sample. In other words, the processing module may be configured to remove the predefined structures from the captured image. The predefined structures may e.g. comprise particles, dust particles, bacteria, macro-molecules, proteins or any other structure being visible on the captured image, and therefore inferring a bias to the determination of the refractive index of the sample. The predefined structures may e.g. be stored in a look-up table and/or a database contained in a data storage device of the apparatus. The processing module may be configured to automatically and/or semi-automatically determine the predefined structures in the captured image in order to filter the structures out of the captured image. This allows correction of the bias inferred by the predefined structures, thereby increasing an accuracy and precision of the determination of the refractive index. The filter function may be realized in the processing module e.g. by means of implemented software and/or implemented software modules.

According to an embodiment, the processing module is configured to filter out the predefined structures based on a segmentation of the captured image. In other words, the processing module may be configured to apply segmentation techniques to the captured image to remove the predefined structures from the captured image. By way of example, the processing module may be configured to crop regions of the captured image, in which the predefined structures are located and/or captured in order to remove the predefined structures from the captured image. Thus, the processing module may be configured to select particle-free areas of the captured image and/or sections of the captured image, which are free of predefined structures. By selecting only particle-free areas and/or sections of the captured image, a quality and/or precision of the refractive index measurement may be improved.

According to an embodiment, the processing module is configured to determine the predefined structures based on a morphology analysis, a contrast analysis, and/or based on a classification of the predefined structures. Referring to morphology analysis, the predefined structures may be determined e.g. based on a specific structure, geometry, shape, profile and/or form of the predefined structures, wherein parameters related to the morphology may be stored e.g. in a look-up table and/or a database of the apparatus. Referring to contrast analysis, contrast variations such as bright and/or dark regions with respect to an average brightness of the captured image may be determined by the processing module. For this purpose, e.g. threshold values of contrast and/or brightness may be stored e.g. in look-up table and/or a database of the apparatus. Referring to classification, the processing module may be configured for machine learning by applying a classifier in order to classify certain predefined structures by means of characteristics of the respective structures. Such characteristics and/or classification criteria may be stored e.g. in a look-up table and/or a database of the apparatus.

According to an embodiment, the processing module is configured to determine pixel intensity values of at least a part of the photosensitive pixels, wherein the processing module is configured to determine the transmittance and/or the reflectance based on an average intensity value of the determined pixel intensity values. Accordingly, the processing module may be configured to determine the average intensity value based on the pixel intensity values. The average intensity value may provide a reliable measure for the transmittance and/or the reflectance. Thus, by evaluating the average intensity value and by deriving the reflectance and/or the transmittance therefrom, the refractive index may be reliably and precisely determined.

According to an embodiment, the processing module is configured to determine the transmittance and/or the reflectance based on a ratio of the average intensity value and a reference intensity value, wherein the reference intensity value is stored in a look-up table and/or a database of the apparatus. The ratio of the average intensity value and the reference intensity value may be proportional to the reflectance and/or the transmittance, which in turn may be a function of the refractive index of the sample. Thus, by determining and/or calculating the ratio, the refractive index may be precisely determined. The reference intensity value may e.g. be calculated based on well-established theoretical models, such as the rigorous coupled-wave analysis, the modal method and/or the Chandezon method. Further, the reference intensity value may be determined in calibration measurements and stored e.g. in the look-up table and/or the database.

According to an embodiment, the cartridge comprises a first region, in which the optical element is arranged, and a second region. The second region may be free and/or entirely free from the optical element. In other words, the second region may be emptied from the optical element and/or the optical element may only be arranged in the first region. The imaging unit is configured such that the captured image comprises a first image section of the first region and a second image section of the second region, wherein the processing module is configured to determine the transmittance and/or the reflectance based on a ratio of a first average intensity value of photosensitive pixels capturing the first image section and a second average intensity value of photosensitive pixels capturing the second image section. Thus, the processing module may be configured to determine the first average intensity value of photosensitive pixels capturing the first image section and the second average intensity value of photosensitive pixels capturing the second image section. The second average intensity value may refer to a reference intensity value. The ratio of the first average intensity value and the second average intensity value may be proportional to the reflectance and/or the transmittance, which in turn may be a function of the refractive index of the sample. Thus, by determining and/or calculating the ratio, the refractive index may be precisely determined.

According to an embodiment, the processing module is configured to determine a specific gravity value of the sample based on the determined refractive index of the sample and based on a conversion function. The conversion function may e.g. be a mathematical function, such as a polynomial function, a linear function or any other function, which depends on the refractive index. Parameters and/or parameter values of the conversion function may be stored e.g. in a look-up table and/or a database. The conversion function and/or the corresponding parameters may be determined by means of measurements and/or statistical analyses.

According to an embodiment, the imaging unit is configured to capture a dark image. The dark image may be captured when the light source is switched to an off-state, in which no light may be emitted by light source. The processing module is configured to determine a dark intensity value based on the captured dark image, wherein the processing module is further configured to determine the transmittance and/or the reflectance taking into account the dark intensity value. The dark image intensity value may e.g. be subtracted from an average intensity value of the captured image. This may further improve a precision and accuracy in the determination of the refractive index.

According to an embodiment, the optical element is a diffractive optical element configured to diffract the light beam into at least two diffraction orders, wherein the objective lens and the diffractive optical element are configured such that the objective lens receives the at least two diffraction orders, and wherein the imaging unit is configured to capture two separate images of the at least two diffraction orders. In other words, one image per diffraction order may be captured by the imaging unit. For instance, the apparatus and/or the imaging unit may be configured to filter each of the diffraction orders separately in order to provide only one diffraction order at a time to the image sensor and/or in order to capture two separate images of the at least two diffraction orders. The objective lens and the optical element may e.g. be adjusted and/or matched with respect to their characteristic properties and/or parameters. By way of example, an aperture of the objective lens and/or a distance of the objective lens to the diffractive optical element may be matched with a pitch, a groove height and/or a line width of a grating, which may serve as diffractive optical element, such that the diffractive optical element generates at least two diffraction orders which may be received and/or collected by the objective lens. By capturing two separate images of the at least two diffraction orders, redundancy in the measurement of the refractive index may be achieved, thereby increasing a precision of the measurement. Also, by comparing the images of the at least two diffraction orders, there may be no need for taking a reference intensity value into account in order to determine the reflectance and/or the transmittance.

According to an embodiment, the optical element is a refractive optical element configured to refract the light beam into at least a first beam portion with a first beam direction and a second beam portion with a second beam direction. The first beam direction may differ from the second beam direction. The objective lens and the refractive optical element are configured such that the objective lens receives the first beam portion and the second beam portion, wherein the imaging unit is configured to capture two separate images of the first beam portion and the second beam portion. In other words, one image per beam portion may be captured. For instance, the apparatus may be configured to filter each of the beam portions separately in order to provide only one beam portion at a time to the image sensor and/or in order to capture two separate images of the at least two beam portions. By way of example, the refractive optical element may be a line-prism like structure, which may be arranged line-by-line and which may split an impinging beam into three beam portions with different directions. Thus, by adjusting parameters of the objective lens and/or matching them with a shape and/or structure of the refractive element, the at least two beam portions may be collected and/or received with the objective lens. By capturing two separate images of the at least two beam portions, redundancy in the measurement of the refractive index may be achieved, thereby increasing a precision of the measurement. Also, by comparing the images of the at least two beam portions, there may be no need for taking a reference intensity value into account in order to determine the reflectance and/or the transmittance.

According to an embodiment, the optical element is at least one of a phase diffractive optical element, an amplitude diffractive optical element, a refractive element and/or an element comprising structures of mutually different refractive indices. The optical element may e.g. be a grating, such as a line grating with a certain pitch, groove and/or line width, which may serve as diffractive optical element. Such grating may be two-dimensional or three-dimensional. The optical element may also be a grid, which may serve as diffractive optical element. Further, by way of example the optical element may comprise a certain geometrical profile, such as e.g. a trapezoidal, a triangular and/or a prism-like geometrical profile, which may be used to refract and/or diffract at least a part of the light beam. The geometrical profile may be arranged in an array on a surface of the optical element. For instance, the optical element may e.g. comprise an array of line prisms configured to refract at least a part of the light beam.

According to an embodiment, the imaging unit is configured to perform optical sectioning microscopy. Alternatively or additionally, the apparatus may further comprise a stage for supporting the cartridge, wherein the light source and the image sensor of the imaging unit are tilted with respect to a main plane of the stage. The sample may e.g. be scanned in order to get a full image thereof. This way, a precision in the determination may be increased.

According to the second aspect of the invention a cartridge for use in the apparatus as described above and in the following is provided. The cartridge comprises a first plate, a second plate, and a chamber arranged between the first plate and the second plate, the chamber being configured to receive and/or contain the sample. The cartridge further comprises a first diffractive optical element with a first geometrical profile configured to diffract at least a part of a light beam into at least one diffraction order, and a second diffractive optical element with a second geometrical profile configured to diffract at least a part of a light beam into at least one diffraction order, Therein, the first diffractive optical element and the second diffractive optical element are arranged on at least one of the first plate and the second plate. The first and the second diffractive optical elements may be arranged on the same plate or on different plates. The first and second optical elements may be arranged on a side of at least one of the plates, which side may be directed towards and/or may be in direct contact with the chamber. The chamber may be formed and/or at least partly encompassed by the first and second plate. Further, the first geometrical profile differs from the second geometrical profile in a profile shape. The profile shape may in this context refer to a geometrical characteristic of the first and second geometrical profiles, respectively. By way of example the first and second geometrical profiles may refer to at least one of a trapezoidal, a triangular, a symmetric, and/or an asymmetric geometrical profile as well as a certain gratin profile with e.g. a specific pitch, line width and/or groove height. Accordingly, the first geometrical profile may differ from the second geometrical profile e.g. in shape, dimension, geometry and/or in any other of the aforementioned characteristics of the first and second profiles. This allows to optimize each of the first and second diffractive optical elements for a specific range of refractive index, thereby allowing to determine a broad range of refractive index with a single cartridge. The cartridge may also comprise more than two diffractive optical elements.

According to an embodiment, the first diffractive optical element and the second diffractive optical element are gratings and/or diffractive gratings, wherein the first geometrical profile differs from the second geometrical profile in at least one of a pitch, a groove height, and a line width. Accordingly, with each of the gratings a specific refractive index range may be determined, thereby allowing to determine a broad range of refractive index with a single cartridge.

According to a third aspect of the invention, a method for determining a refractive index of a sample is provided. The method comprises the steps of:
providing a cartridge comprising the sample and an optical element;
irradiating, with a light source, at least a part of the cartridge with a light beam;
diffracting and/or refracting, with the optical element, at least a part of the light beam;
receiving, with an objective lens, the refracted and/or diffracted part of the light beam;
capturing, with an image sensor, an image generated and/or formed by the objective lens;
determining, with a processing module, a transmittance and/or a reflectance of the sample by analyzing an image intensity of the captured image; and
determining the refractive index of the sample based on the transmittance and/or based on the reflectance.

It is to be noted that any feature, characteristic, element and/or function described above and in the following with respect to the apparatus and/or the cartridge may be a feature, characteristic, element and/or step of the method, and vice versa.

These and other aspects of the invention will be apparent from and elucidated with reference to the embodiments described hereinafter.

### BRIEF DESCRIPTION OF THE DRAWINGS

The subject matter of the invention will be explained in more detail in the following with reference to exemplary embodiments which are illustrated in the attached figures, wherein:

FIG. 1 shows schematically an apparatus for determining a refractive index of a sample according to an embodiment;

FIG. 2 shows schematically an apparatus for determining a refractive index of a sample according to an embodiment;

FIG. 3 shows schematically an apparatus for determining a refractive index of a sample according to an embodiment;

FIGS. 4A to 4C each show an image captured with an apparatus for determining a refractive index of a sample according to an embodiment;

FIGS. 5A to 5C illustrate a functionality of an apparatus for determining a refractive index of a sample according to an embodiment;

FIG. 6 shows schematically a top view of a cartridge according to an embodiment;

FIG. 7 shows a flow chart illustrating steps of a method for determining a refractive index of a sample according to an embodiment.

In principle, identical, like and/or similar parts are provided with the same reference symbols in the figures. The figures are not to scale.

### DETAILED DESCRIPTION OF EMBODIMENTS

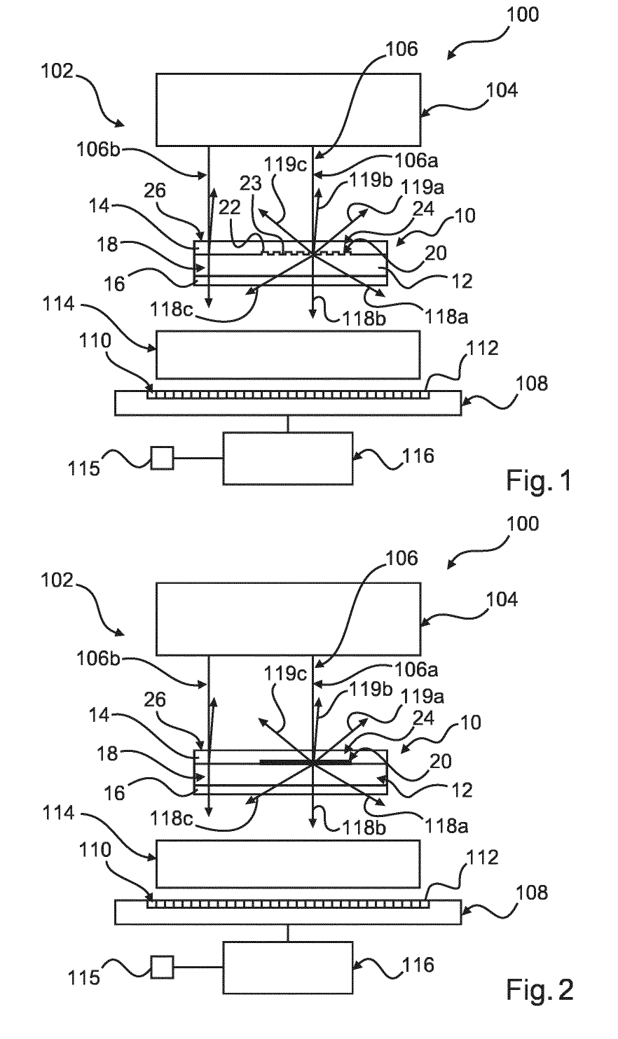

FIG. 1 shows schematically an apparatus 100 for determining a refractive index nₛ of a sample 12 according to an embodiment. The apparatus 100 comprises a cartridge 10 for receiving a sample 12 and/or a sample material 12.

The apparatus 100 further comprises an imaging unit 102. The imaging unit 102 comprises a light source 104 for irradiating at least a part of the cartridge 10 with a light beam 106. The light source 104 may emit a light beam 106 with arbitrary wavelength. The light source 104 may be e.g. a white light source 104 or a laser device 104.

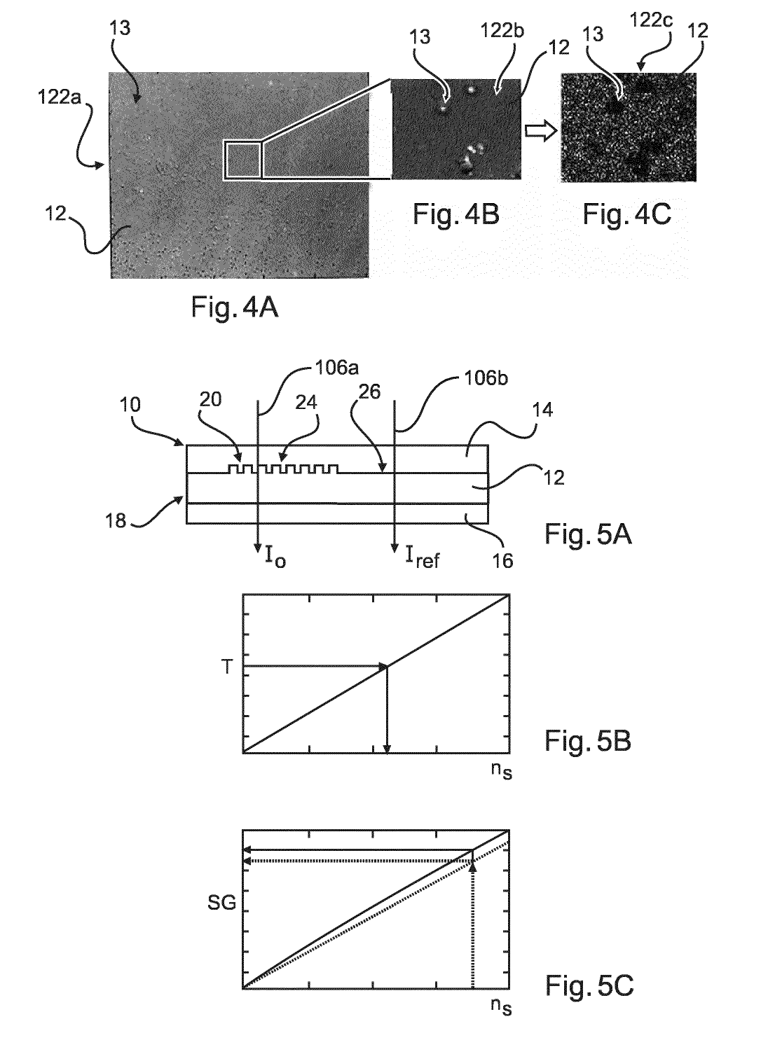

The imaging unit 102 further comprises an image sensor 108 with an array 110 of photosensitive pixels 112 for capturing an image 122a, 122b (see FIGS. 4A, 4B) of the part of the cartridge irradiated with the light source 104. The photosensitive pixels 112 may e.g. be CCD-based and/or CMOS-based pixels 112, wherein the pixels 112 are configured to convert impinging light into electrical signals.

The imaging unit 102 further comprises an objective lens 114 configured and/or arranged to form an image of the irradiated part of the cartridge 10 on the image sensor 108. The objective lens 114 may generally refer to an objective 114 and may comprise a plurality of lenses.

The imaging unit 102 further comprises a processing module 116, processing circuit 116, processing circuitry 116, and/or processing unit 116 configured for analyzing the image 122a, 122b (see FIGS. 4A, 4B) captured by means of the image sensor 108. The processing module 116 may be configured to directly evaluate and/or analyze electrical signals from the pixels 112. Alternatively or additionally, the electrical signals of the pixels 112 may be converted by the imaging unit 102 into digital image data, which may be stored in a data storage device 115 of the imaging unit 102. Thus, the captured image 122a, 122b may refer to the stored digital image data, which may be evaluated and/or processed by the processing module 116.

The cartridge 10 comprises a first plate 14 and a second plate 16, which are arranged substantially parallel with respect to each other. The first plate 14 and/or the second plate 16 may refer to windows and/or plate-like support structures. The first plate 14 and the second plate 16 are spaced apart from each other, such that a chamber 18, e.g. a planar chamber 18, is formed between the first plate 14 and the second plate 16. In chamber 18, the sample 12 is contained and/or arranged, wherein the chamber may be partly or completely filled with the sample 12 and/or the sample material 12. The first plate 14, the second plate 16 and/or the cartridge 10 may be manufactured from any polymer and/or from glass. Particularly, the material of the first plate 14, the second plate 16 and/or the cartridge 10 may be optically transparent. By way of example, the material may comprise Cyclo Olefin Polymer (COP), Polycarbonate (PC), Polystyrene (PS), Polymethylmethacrylate (PMMA), and/or styrene-butadiene copolymers (SBC). With respect to the light path of the light beam 116 propagating from the light source 104 to the image sensor 108, the first plate 14 is arranged closer to the light source 104 than the second plate 16. Accordingly, with respect to the light path, the first plate 14 may refer to a top plate 14 and the second plate 16 may refer to a bottom plate 16.

The cartridge 10 further comprises an optical element 20 configured to refract and/or diffract at least a part of the light beam 106. The optical element 20 is arranged on a side of the first plate 14, which side faces and/or is directed towards the chamber 18. This arrangement may avoid settling and/or agglomeration of particles and/or structures potentially comprised in the sample 12. Generally, the optical element 20 may be at least one of a phase diffractive optical element 20, an amplitude diffractive optical element 20, a refractive prism 20, a micro-structured element 20 and/or an element 20 comprising structures of mutually different refractive indices.

Further, the optical element 20 may be integrally formed with the cartridge 10 and/or the first plate 14. For instance, the cartridge 10 may be injection molded in one piece. Alternatively, the optical element 20 may be glued and/or soldered to the first plate 14. The optical element 20 may be manufactured from the same material as the first plate 14 and the second plate 16, or it may be manufactured from different material. Particularly, the optical element 20 may be manufactured from polymer, such as PMMA, COP, PC, PS, and/or SBC, and/or glass, such as P-SF 67, P-PK 53, and/or N-BK7. Particularly, the optical element 20 may be manufactured from graded polymer and/or optically graded glass. Moreover, the material of the optical element 20 may be selected such that a temperature dependency of the material's refractive index is minimized, removed and/or adjusted to a respective temperature dependency of the sample's 12 refractive index nₛ. This allows for a more robust and precise determination of the refractive index nₛ of the sample 12.

Exemplary, the optical element 20 shown in FIG. 1 is depicted as grating 20, e.g. as line grating 20. However, if not stated otherwise, features described with reference to FIG. 1 are not restricted to the optical element 20 being a grating 20. As shown in FIG. 1, the optical element 20 comprises a plurality of substantially parallel grooves 22 and ridges 23, which each are partly or completely filled with sample material 12. The grooves 22 are arranged with a certain pitch and/or distance between neighboring grooves 22. By way of example, the optical element 20 may be a line grating with a size of about 100 μm² to about 3 mm², having a pitch of about 0.5 μm to about 2 μm and a groove height h of about 0.5 to 2 μm.

Moreover, the optical element 20 is arranged in a first region 24 of the cartridge 10, wherein the cartridge 10 further comprises a second region 26, which is free of and/or emptied from the optical element 20. In other words, no optical element 20 is arranged in the second region 26 of the cartridge 10. As described in more detail in the following, the second region 26 may refer to a reference area, section and/or region of the cartridge 10, which may be used to determine the refractive index nₛ of the sample 12.

The refractive index nₛ of the sample 12 may be determined and/or measured with the apparatus 100 as described in the following. The light beam 106 is emitted by the light source 104 and a first part 106a of the light beam 106 propagates to the first region 24 of the cartridge 10, in which the optical element 20 is arranged. A second part 106b of the light beam 106 propagates to the second region 26 of the cartridge 10, in which no optical element 20 is arranged. The first part 106a of the light beam 106 propagating through the optical element 20, which is exemplary designed as a grating 20 in FIG. 1, is phase delayed differently by the ridges 23 with respect to the grooves 22 filled with sample material 12. Thus, the first part 106a of the light beam 106 having passed the grooves 22 and/or ridges 23 undergoes interference, i.e. constructive or destructive interference, and at least one diffraction order 118a, 118b, 118c is generated. In the example of FIG. 1, three diffraction orders 118a, 118b, 118c are shown. Alternatively or additionally, diffraction of the first part 106a of the light beam 106 may result in a reflection of at least part of the first part 106 in at least one reflection order 119a, 119b, 119c, as schematically depicted in FIG. 1. This effect allows to determine the refractive index nₛ by capturing an image of at least one of the diffraction orders 118a-c and/or by capturing an image of at least one of the reflection orders 119a-c.

In principle, the apparatus 100 shown in FIG. 1 is configured to determine the refractive index nₛ of the sample 12 by means of a diffraction measurement where a single diffraction order 118a-c, e.g. the transmitted 0th diffraction order 118b, or multiple diffraction orders 118a-c are measured, captured and/or determined. Again, it is to be noted, that both the diffraction orders 118a-c and the reflection orders 119a-c may be used for determined the refractive index nₛ. The diffraction orders 118a-c and/or the reflection orders 119a-c are generated at the boundary between the optical element 20 and the sample 12, and thus carry information of the refractive index nₛ of the sample 12. In other words, the optical element 20 represented as a grating in FIG. 1 generates higher order diffracted beams, i.e. the incoming light beam 106a is by the optical element 20 split up into multiple well-defined beams depicted as diffraction orders 118a-c and/or reflection orders 119a-c. The redistribution of optical energy between the diffraction orders 118a-c and/or the reflection orders 119a-c depends strongly on the refractive index nₛ of the sample 12, wherein the direction of the orders 118a-c, 119a-c may be determined by a grating pitch, while the refractive index of the optical element's 20 material and the profile shape of the optical element 20 may determine the diffraction/reflection efficiencies. Note that the refractive index of the material of the first plate 14 and the second plate 16 is assumed to be known and different from refractive index nₛ of the sample 12.

The phase delay Δφ inferred to the first part 106a of the light beam 106 transmitted through and/or reflected by the optical element 20 is proportional to the difference of the refractive indices Δn of the sample 12 (and/or the sample material 12) and the optical element. This difference of the refractive indices, denoted as Δn, may be expressed as Δn=nₛ−nₒ, with nₛ referring to the refractive index of the sample 12 and nₒ referring to the refractive index of the optical element 20. Moreover, the transmittance T of the sample 12 is further proportional to the phase delay Δ_{T}.

Applying a rough 0-order approximation, a functional dependency of the phase delay Δφ, which is proportional to the refractive index difference Δn=nₛ−nₒ between the optical element 20 (and/or a ridge 23) and the sample 12 in one of the grooves 22, and the transmittance T may be given by

$$T ∝ {sin}^{2} ( Δϕ ) = {sin}^{2} ( \frac{π}{λ} \cdot h \cdot Δ n ) ,$$

where λ is the wavelength of the light, h is the height of the ridge 23 and/or the groove 22 (i.e. the grating line). As can be seen, a clever choice of groove heights h makes the transmittance T sensitive to changes to the refractive index nₛ of the sample 12. However, it is to be noted that this equation is only a rough approximation. Other theories for a more accurate calculation are available. They all are based on Maxwell's equations, exact boundary conditions, and illumination conditions. Examples of such methods are the rigorous coupled-wave analysis (RCWA), modal method, and Chandezon method.

As a consequence of conservation of energy, the sum of the transmittance T and the reflectance R equals 1. Thus, also the reflectance R is proportional to the phase delay Δφ. Accordingly, the transmittance T and the reflectance R are a function of the phase difference Δφ and thus also a function of the difference of refractive indices Δn. Therefore, by determining the transmittance T and/or the reflectance R, the refractive index nₛ of the sample 12 can be determined.

Generally, an image intensity I of the captured image is a function of the transmittance T and/or the reflectance R. This allows to determine the transmittance T and/or the reflectance R based on analyzing the image intensity I by means of the processing module 116. Thus, the processing module 116 is configured to determine the transmittance T and/or the reflectance R of the sample 12 by analyzing the image intensity I, and to determine the refractive index nₛ based on the transmittance T and/or the reflectance R.

Further, to improve precision of the determination of the sample's 12 refractive index nₛ a relative intensity comparison between an intensity I_{ref} of the second part 106b of the light beam 106, which may serve as reference beam, and an intensity 10 of the first part 106a of the light beam 106 propagated through the optical element 20 provides a measure for the sample's refractive index nₛ. The intensities Iₒ and I_{ref} can be derived from the captured image 122a,b (see FIGS. 4A, 4B) and/or from the average intensity values of the pixels 112, which detect the first part 106a and the second part 106b of the light beam 106, respectively. Accordingly, the imaging unit 102 is configured such that the captured image comprises a first image section of the first region 24 and a second image section of the second region 26, wherein the processing module 116 is configured to determine the transmittance T and/or the reflectance R based on the ratio of a first average intensity value Iₒ of photosensitive pixels 112 capturing the first image section and a second average intensity value I_{ref} of photosensitive pixels 112 capturing the second image section. Alternatively or additionally, the intensity value I_{ref} of the second part 106b propagated through and/or reflected by the second region 26 of the cartridge 10 may also be calculated applying well-established theoretical models and/or by performing calibration measurements and storing the intensity value I_{ref} e.g. in a look-up table and/or a database of the apparatus 100. In other words, the relation between the sample's 12 refractive index nₛ and the measured signal and/or the determined average intensity value Iₒ in the first section of the captured image may be established by measurements and/or modeling based on well-established theories. Another way to measure the refractive index nₛ is to use more than one diffraction order 118a-c (and/or reflection orders 119a-c), including the 0th order 118b (119b).

Apart from the aforementioned aspects, features, functions and/or elements of the apparatus 100, various other aspects, features, functions and/or elements may be employed in the apparatus 100 in order to improve a quality of the determination of the sample's refractive index nₛ Such additional features are summarized in the following.

Optionally, the imaging unit 102 may be configured to capture a dark image, wherein the processing module 116 may be configured to determine a dark intensity value I_{dark} based on the captured dark image. The dark intensity value I_{dark} may be determined by averaging the intensity values of a part of or of all pixels 112, when the light source 104 is switched off. The dark intensity value I_{dark} may then be subtracted from the first average intensity value Iₒ of photosensitive pixels 112 capturing the first image section and the second average intensity value I_{ref} of photosensitive pixels 112 capturing the second image section.

Further, the illuminated captured image may be split and/or cropped into the first image section, in which the first region 24 of the cartridge 10 with the optical element 20 is captured, and the second image section, in which the second region 26 of the cartridge 10 is captured. The first image section may thus refer to a region acquired with the optical element 20 and the second image section may refer to a region acquired without optical element 20.

Moreover, a segmentation and/or a segmentation technique may be applied by the imaging unit 102 and/or the processing module 116 to identify predefined structures, such as e.g. particles and/or other sources such as imperfections in the cartridge 10, causing abnormal effects and/or a bias not related to the refractive index nₛ of the sample 12, as described in more detail with reference to FIGS. 4A to 4C.

Further, filters may be employed in the processing module 116 to validate functionality of the pixels 112. By way of example, the processing module 116 may be configured to determine and/or to remove over/under sensitive, saturated and/or dead pixels 112. The complementary set of segmented pixels 112—denoted the validated pixel set may be those to be used the further determination of the refractive index nₛ of the sample 12.

Further, the processing module 116 may be configured to average pixel intensity values in the first and second image section and calculate the transmittance T, e.g. via T=(Iₒ−I_{dark})/(I_{ref}−I_{dark}).

From a look-up table containing a relation between the transmittance T and the refractive index nₛ of the sample 12 and/or based on a respective function, the refractive index nₛ may be determined form the transmittance T. In analog manner, the reflectance R may be used instead of the transmittance T. The look-up table and/or the function correlating nₛ and T may be determined in calibration measurements.

To improve the precision, the objective lens 114 and the optical element 20 may further be configured such that the objective lens 114 receives at least two diffraction orders 118a-c, wherein the imaging unit 102 is configured to capture two separate images of the at least two diffraction orders 118a-c.

Moreover, the processing module 116 may be configured to determine a specific gravity value SG of the sample 12 based on the determined refractive index nₛ of the sample 12 and based on a conversion function, as described in more detail with reference to FIGS. 5A to 5C.

Further, it is to be noted that e.g. for cloudy samples 12 the transmitted diffraction signal may be strongly disturbed by the angular dispersion of the light beam 106 due to optical scattering within the sample 12. Thus, the light collection for the transmittance measurement may be affected by scattering loss and/or contributions from scattered higher order beams.

An approach and/or a method of overcoming the scattering effect from cloudy samples 12 is decreasing the sample thickness and/or measuring the reflected signals 119a-c, and/or the reflected orders 119a-c. Reflected diffraction orders 119a-c are only probing the sample-optical element boundary without propagating through the sample 12. This means the reflected orders 119a-c may not be affected by optical scattering in the sample 12 which otherwise leads to angular dispersion of the beam directions. The reflection measurement may be conducted for an oblique angle of incidence of the light beam 106 to avoid reflected signals from containing windows and/or walls behind the sample 12.

FIG. 2 shows schematically an apparatus 100 for determining a refractive index nₛ of a sample 12 according to an embodiment. If not stated otherwise, the apparatus 100 of FIG. 2 comprises the same features, functions and/or elements as the apparatus 100 described with reference to FIG. 1.

In contrast to the apparatus 100 of FIG. 1, the apparatus 100 shown in FIG. 2 comprises a refractive optical element 20 configured to refract at least a part of the first part 106a of the light beam 106. The refractive optical element 20 may comprise a refractive geometrical profile, such as e.g. a trapezoidal, a triangular, a symmetric and/or an asymmetric geometrical profile. By way of example, the refractive optical element 20 may comprise a line-prism like structure and/or an array of line prisms configured to split the first part 106a of the light beam 106 into three beam portions 118a-118c with different directions, which are transmitted through the cartridge 10. The refractive optical element 20 may alternatively or additionally reflect the first part 106a of the light beam in three beam portions 119a-c with different directions, as indicated in FIG. 2.

Generally, in order to determine the refractive index nₛ of the sample 12 for example total internal reflection (TIR) in the refractive optical element 20 and/or in a geometrical profile of the refractive optical element 20 may be used. This may be achieved by providing slopes of e.g. prisms and/or prism sides near the critical angle, above which TIR occurs. As the refractive index nₛ of the sample 12 changes, the critical angle also changes accordingly. This may result in a changed amount of light being reflected by and/or transmitted through the refractive optical element 20, which in turn may allow to determine the refractive index nₛ of the sample 12.

In order to determine the refractive index nₛ of the sample 12, the same principle as described with reference to FIG. 1 is applied. The only difference being that not at least one diffraction order 118a-c and/or reflection order 119a-c is used to determine the refractive index nₛ of the sample 12, but rather at least one of the beam portions 118a-c, 119a-c is used.

Further, the objective lens 114 and the refractive optical element 20 may be configured such that the objective lens 114 receives the first beam portion 118b and the second beam portion 118a, 118c, wherein the imaging unit 102 is configured to capture two separate images of the first beam portion 118b and the second beam portion 118a, c. The first beam portion 118b may refer to a beam portion, which may be directly transmitted through the cartridge 10 without bending the light.

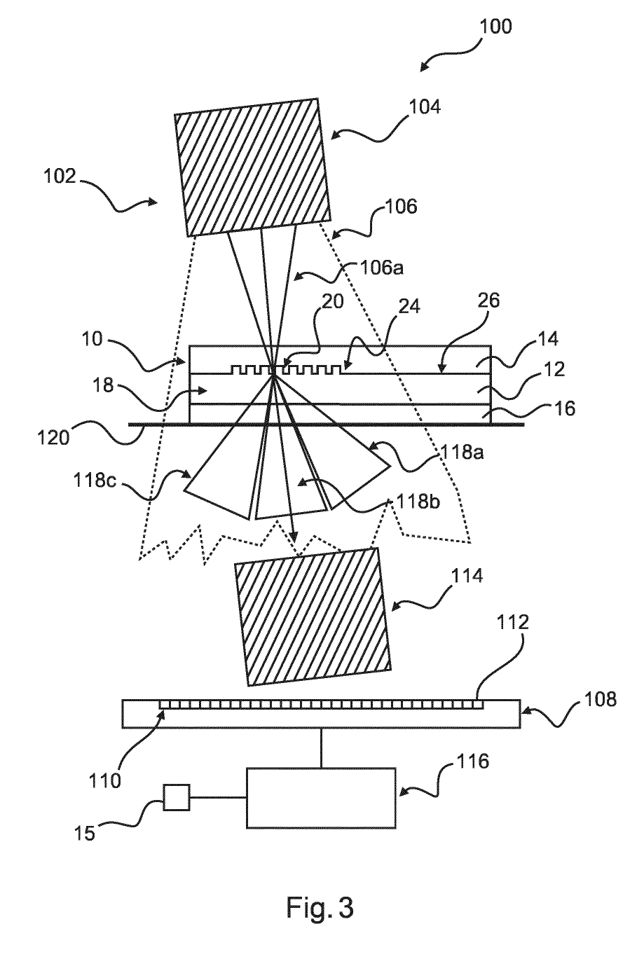

FIG. 3 shows schematically an apparatus 100 for determining a refractive index nₛ of a sample 12 according to an embodiment. If not stated otherwise, the apparatus 100 of FIG. 3 comprises the same features, functions and/or elements as the apparatus 100 described with reference to FIGS. 1 and 2.

The apparatus 100 of FIG. 3 comprises a stage 120, on which the cartridge 10 is arranged and which is configured to support and/or carry the cartridge 10. The stage 120 is arranged in a main plane of the stage 120, wherein the imaging unit 102 is configured to perform optical sectioning microscopy. Therefore, the light source 104 and the image sensor 108 of the imaging unit 102 are tilted with respect to the main plane of the stage 120, as shown in FIG. 3. In other words, the optical axis may be oblique with respect to the main plane of the stage 120. In order to acquire a complete image of the cartridge 10, the cartridge 10 may be scanned, wherein the stage 120 and the imaging unit 102 may be displaced relative to each other.

By way of example, each point of the sample 12 may be illuminated with light having an angle of incidence in the range of 1° to 89°, particularly ranging from 1° to 20°, preferably ranging from 7° to 8°. Further, an angle of acceptance of the objective lens 114 may range from −20° to +20°, preferably from 7° to 8°.

Generally, a numerical aperture (NA) of the objective lens 114 may be less than an angular separation between the at least one diffraction order 118a-c collected by the objective lens 114 and a neighboring diffraction order 118a-c. The same may apply to the beam portions 118a-c in case the optical element 20 is a refractive optical element 20. This may allow to collect only the wanted diffraction order 118a-c (and/or beam portion 118a-c) and/or to avoid pollution of the detected diffraction order 118a-c by other diffraction orders 118a-c, i.e. by collecting more than one diffraction order 118a-c. Further, since the light source 104 also has an angular distribution as exemplified in FIG. 3—the numerical aperture of the objective lens 114 may be reduced accordingly. As a consequence, the numerical aperture of the objective lens 114 may be selected to only collect a single diffraction order 118a-c and to form an image of the sample 12 based on this single diffraction order 118a-c. The same may apply to the beam portions 118a-c in case the optical element 20 is a refractive optical element 20. Alternatively or additionally, the optical element 20 may be selected such that the objective lens 114 only collects a single diffraction order 118a-c and/or a single beam portion 118a-c.

FIGS. 4A to 4C each show an image 122a-c captured with an apparatus 100 for determining a refractive index nₛ of a sample 12 according to an embodiment. The captured images 122a-c may be acquired with any of apparatus 100 as described with reference to one of FIGS. 1 to 3. FIG. 4A shows a raw image 122a, FIG. 4B shows a cropped part 122b of the image 122a of FIG. 4A, and FIG. 4C shows a segmented image 122c of the cropped image 122b of FIG. 4B. Each of the images 122a-c is shown in arbitrary units and/or coordinates.

In FIG. 4A the captured image 122a of the first region 24 of the cartridge 10 comprising the optical element 20 is shown in raw form. Accordingly, the image 122a may refer to the first image section, in which the optical element 20 is captured, as described in more detail in the foregoing description. As can be seen in FIG. 4A, the sample 12 and/or the sample material 12 contains impurities and/or additives, identifiable as structures 13 and/or predefined structures 13. The predefined structures 13 are even more clearly visible in the cropped image 122b of FIG. 4B. For instance, the sample 12 may be urine and the structures 13 may refer to particles, dust particles, bacteria, macro-molecules, proteins, and/or impurities in the first plate 14 and/or the second plate 16 of the cartridge. Such structures 13 may negatively affect the determination of the refractive index nₛ of the sample 12 by inferring a bias to the measurement.

In order to improve a quality and precision of the determination of the refractive index nₛ of the sample 12, the processing module 116 is configured to filter out and/or remove the predefined structures 13 in the captured image 122a, 122b. For this purpose, the processing module 116 is configured to apply and/or perform a segmentation of the captured image 122a, 122b. For the segmentation and/or the identification of the predefined structures, the processing module 116 is configured to apply and/or to perform a morphology analysis, a contrast analysis, and/or a classification of the predefined structures 13. Referring to morphology analysis, the predefined structures 13 may be determined e.g. based on a specific structure, geometry, shape, profile and/or form of the predefined structures 13, wherein parameters related to the morphology may be stored e.g. in a look-up table and/or a database of the apparatus 100. Referring to contrast analysis, contrast variations such as bright and/or dark regions with respect to an average brightness of the captured image 122a, 122b may be determined by the processing module 116. For this purpose, e.g. threshold values of contrast and/or brightness may be stored e.g. in look-up table and/or a database of the apparatus 100. Referring to classification, the processing module 116 may be configured for machine learning by applying a classifier in order to classify certain predefined structures 13 by means of characteristics of the respective structures 13. Such characteristics and/or classification criteria may be stored e.g. in a look-up table and/or a database of the apparatus. Applying any of these techniques, the segmented image 122c as shown in FIG. 4C may be derived, from which the predefined structures 13 can easily be detected and thus removed from the raw images 122a, 122b, which may after removing the predefined structures 13 be used to determine the refractive index nₛ of the sample 12 as described in detail with reference to FIGS. 1 to 3.

FIGS. 5A to 5C illustrate a functionality of an apparatus 100 for determining a refractive index nₛ of a sample 12 according to an embodiment. The functionality described with reference to FIGS. 5A to 5C may be applied in any of the apparatus 100 described in previous figures.

In FIG. 5A the measurement and/or detection principle applied in the apparatus 100 is schematically depicted. As described in more detail in previous figures, a first part 106a of a light beam 106 emitted by the light source 104 is propagated through a first region 24 of the cartridge 10, in which the optical element 20 is arranged, and finally captured as first image section in the captured image 122a. Further, the second part 106 of the light beam 106 is propagated through the second region 26 of the cartridge 10, which is captured as second image section in the captured image. The first image section is evaluated by the processing module 116 to derive the first average intensity value L. Moreover, the second image section is evaluated by the processing module 116 to derive the second average intensity value I_{ref}. As the transmittance T is proportional to the ratio of the first average intensity value L and the second average intensity value I_{ref}, the transmittance can be determined from the captured image.

FIG. 5B shows in arbitrary units a relation and/or functional dependence of the transmittance T and the refractive index nₛ of the sample 12. As can be seen, by knowing the transmittance T, the refractive index nₛ of the sample 12 can be determined.

Further, based on the refractive index nₛ of the sample 12, for instance a specific gravity value SG of the sample may be derived. For this purpose, a conversion function describing a functional dependence of the specific gravity value SG and the refractive index nₛ of the sample 12 may be used. Such conversion function is shown in arbitrary units in FIG. 5C, exemplary for an urine sample 12 of two different animals.

The conversion function of measured refractive index nₛ of a urine sample 12 into specific gravity SG is well-established e.g. for humans, dogs and cats. These established relations are as standard reported at a reference temperature of 20° C. and an illumination reference wavelength of 589.3 nm (Sodium D-line). By way of example, the conversion functions shown in FIG. 5C between specific gravity SG and refractive index nₛ may be polynomial functions of the third order, wherein parameters of the conversion functions may be stored e.g. in a look-up table and/or a database of the apparatus 100, enabling the apparatus 100 to calculate the specific gravity value SG based on a determined refractive index nₛ of the sample 12.

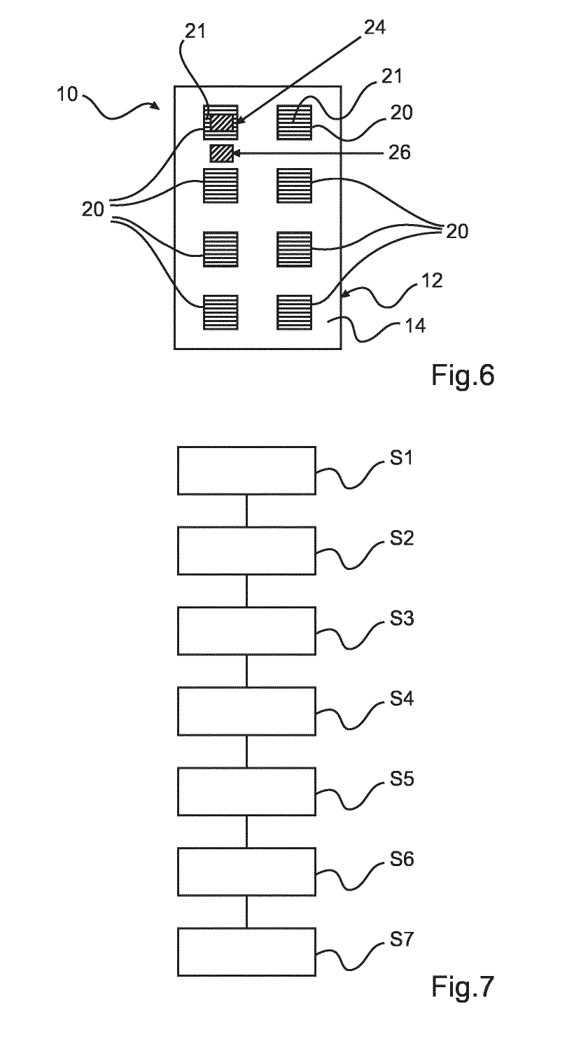

FIG. 6 shows schematically a top view of a cartridge 10 according to an embodiment. If not stated otherwise, the cartridge 10 shown in FIG. 6 comprises the same features, functions and/or elements as the cartridges 10 described in previous figures.

The cartridge 10 comprises a plurality of diffractive optical elements 20 configured to diffract at least a part of a light beam 106, 106a into at least one diffraction order 118a-c. In total, the cartridge comprises eight optical elements 20 arranged in two columns and four rows in the cartridge 10. However, the optical elements 20 may be arranged in an arbitrary pattern. Further, the cartridge 10 may also comprise more than or less than eight optical elements 20. Particularly, the cartridge 10 may comprise at least a first optical element 20 and a second optical element 20.

Each of the optical elements 20 has a specific geometrical profile 21, wherein the geometrical profiles 21 of at least a part of the optical elements 20 differ from one another in a profile shape. The profile shape may in this context refer to a geometrical characteristic of the geometrical profiles 21. By way of example the geometrical profiles 21 may refer to at least one of a trapezoidal, a triangular, a symmetric, and/or an asymmetric geometrical profile 21 as well as a certain grating profile 21 with e.g. a specific pitch, line width and/or groove height. Accordingly, at least a part of the geometrical profiles 21 of the optical elements 20 may differ from one another e.g. in shape, dimension, geometry and/or in any other of the aforementioned characteristics of the geometrical profiles 21. This allows to optimize each or at least a part of the optical elements 20 for a specific range of refractive index, thereby allowing to determine a broad range of refractive index with a single cartridge 10.

By way of example, at least a part of the optical elements 20 shown in FIG. 6 may be gratings 20 and/or diffractive gratings 20, wherein the geometrical profile 21 of at least a part of the optical elements 20 may differ in at least one of a pitch, a groove height, and a line width.

Further, the first region 24 of the cartridge, in which one of the optical elements 20 is arranged, and the second region 26 of the cartridge, in which no optical elements 20 is arranged, are shown. Therein, the second region 26 may be any region of cartridge 10, which is free from an optical element 20.

FIG. 7 shows a flow chart illustrating steps of a method for determining a refractive index nₛ of a sample 12 according to an embodiment. The method may be conducted by any of the apparatus 100 described in previous figures.

In a first step S1 a cartridge 10 comprising the sample 12 and an optical element 20 is provided. In a second step S2 at least a part of the cartridge 10 is irradiated with a light beam 106 by means of a light source 104. In a further step S3 at least a part of the light beam 106 is diffracted and/or refracted with the optical element 20. In a further step S4 the refracted and/or diffracted part of the light beam 106 is received with an objective lens 114. In a further step S5 an image 122a, generated by the objective lens 114, is captured with an image sensor 108. In a further step S6 a transmittance T and/or a reflectance R of the sample 12 is determined with a processing module 116 by analyzing an image intensity of the captured image 122a. In a further step S7 the refractive index nₛ of the sample 12 is determined based on the transmittance T and/or based on the reflectance R.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art and practicing the claimed invention, from a study of the drawings, the disclosure, and the appended claims.

In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. An apparatus for determining a refractive index (nₛ) of a sample, the apparatus comprising:
a cartridge for receiving the sample; and
an imaging unit comprising:
a light source for irradiating at least a part of the cartridge with a light beam;
an image sensor with a plurality of photosensitive pixels for capturing an image of said part of the cartridge;
an objective lens (114) arranged in a light path between the light source (104) and the image sensor; and
a processing module for analyzing the captured image;
wherein the cartridge comprises an optical element configured to refract and/or diffract at least a part of the light beam;
wherein the objective lens is arranged to receive the refracted and/or diffracted part of the light beam;
wherein the processing module is configured to determine pixel intensity values of at least a part of the photosensitive pixels,
determine an average intensity value (Iₒ) of the determined pixel intensity values of the captured image;
determine a transmittance and/or a reflectance of the sample based on a ratio of the average intensity value and a reference intensity value (I_{ref}) stored preferably in a look-up table and/or database of the apparatus;
determine the refractive index (nₛ) of the sample based on the transmittance and/or based on the reflectance.

2. The apparatus according to claim 1,
wherein the processing module is configured to filter out predefined structures in the captured image related to additives in the sample.

3. The apparatus according to claim 2,
wherein the processing module is configured to filter out the predefined structures based on a segmentation of the captured image.

4. The apparatus according to claim 2,
wherein the processing module is configured to determine the predefined structures based on a morphology analysis, a contrast analysis, and/or based on a classification of the predefined structures.

5. (canceled)

6. (canceled)

7. (canceled)

8. The apparatus according to claim 1,
wherein the processing module is configured to determine a specific gravity value of the sample based on the determined refractive index (nₛ) of the sample and based on a conversion function.

9. The apparatus according to claim 1,
wherein the imaging unit is configured to capture a dark image;
wherein the processing module is configured to determine a dark intensity value (I_{dark}) based on the captured dark image; and
wherein the processing module is configured to determine the transmittance and/or the reflectance taking into account the dark intensity value (I_{dark}).

10. The apparatus according to claim 9,
wherein the optical element is a diffractive optical element configured to diffract the light beam into at least two diffraction orders (118a-c);
wherein the objective lens and the diffractive optical element are configured such that the objective lens receives the at least two diffraction orders; and
wherein the imaging unit is configured to capture two separate images of the at least two diffraction orders.

11. (canceled)

12. The apparatus according to claim 1,
wherein the optical element is at least one of a phase diffractive optical element, an amplitude diffractive optical element, a refractive element and/or an element comprising structures of mutually different refractive indices.

13. A method for determining a refractive index (nₛ) of a sample, the method comprising the steps of:
providing a cartridge comprising the sample and an optical element;
irradiating, with a light source, at least a part of the cartridge with a light beam;
diffracting and/or refracting, with the optical element, at least a part of the light beam;
receiving, with an objective lens (114), the refracted and/or diffracted part of the light beam;
capturing, with an image sensor having a plurality of photosensitive pixels, an image generated by the objective lens;
determining, with a processing module pixel intensity values of at least a part of the photosensitive pixels;
determining an average intensity value (Iₒ) of the determined pixel intensity values; and
determining a transmittance and/or a reflectance of the sample based on a ratio of the average intensity value and a reference intensity value (I_{ref}) stored in a look-up table and/or database of the apparatus; and
determining the refractive index of the sample based on the determined transmittance and/or based on the determined reflectance.

14. An apparatus for determining a refractive index (nₛ) of a sample, the apparatus comprising:
a cartridge for receiving the sample; and
an imaging unit comprising:
a light source for irradiating at least a part of the cartridge with a light beam;
an image sensor with a plurality of photosensitive pixels for capturing an image of said part of the cartridge;
an objective lens arranged in a light path between the light source and the image sensor; and
a processing module for analyzing the captured image;
wherein the part of the cartridge for being irradiated by the light beam comprises a first region comprising an optical element configured to refract and/or diffract at least a part of the light beam and a second region not comprising said optical element;
wherein the objective lens is arranged to form an image of the irradiated part of the cartridge on the image sensor, thus to receive the refracted and/or diffracted part of the light beam;
wherein the imaging unit is configured such that the captured image comprises a first image section of the first region of the cartridge and a second image section of the second region of the cartridge,
wherein the processing module is configured to:
determine pixel intensity values of at least a part of the photosensitive pixels;
determine a transmittance and/or the reflectance based on an average intensity value (Iₒ) of photosensitive pixels capturing the first image section and a second average intensity value (I_{ref}) of photosensitive pixels capturing the second image section; and
determine the refractive index (ns) of the sample based on the determined transmittance and/or based on the determined reflectance.

15. A method for determining a refractive index (nₛ) of a sample, the method comprising the steps of:
providing a cartridge comprising the sample and an optical element;
irradiating, with a light source, at least a part of the cartridge with a light beam, said part comprising a first region comprising the optical element and a second region not comprising said optical element, wherein the optical element refracts and/or diffracts the part of the light beam irradiating the first region;
diffracting and/or refracting, with the optical element, the part of the light beam irradiating the first region;
receiving, with an objective lens, the part of the light beam that is diffracted and/or refracted by the optical element in the first region and the part of the light beam that is not irradiated by the optical element in the second region;
capturing, with an image sensor having a plurality of photosensitive pixels, an image generated by the objective lens;
determining, with a processing module pixel intensity values of at least a part of the photosensitive pixels;
determining an average intensity value (Iₒ) of the determined pixel intensity values of photosensitive pixels,
determining a transmittance and/or a reflectance of the sample based on a ratio of the average intensity value (Iₒ) of photosensitive pixels capturing the first image section and a second average intensity value (Iref) of photosensitive pixels capturing the second image section; and
determining the refractive index (ns) of the sample based on the determined transmittance and/or based on the determined reflectance.
